(19) United States
(12) Patent Application Publication
(10) Pub. No.: US 2008/0047953 A1
(43) Pub. Date: Feb. 28, 2008

(54) Redundant hot melt adhesive material heater elements and temperature sensors disposed within single cartridge bodies

(75) Inventor: Scott James Hudanish, Hendersonville, TN (US)

Correspondence Address: Steven W. Weinrieb;SCHWARTZ & WEINRIEB, 2001 Jefferson Davis Highway, Crystal Plaza One, Suite 1109, Arlington, VA, 22202, US

(73) Assignee: ILLINOIS TOOL WORKS INC.

(21) Appl. No.: 11/503,139

(22) Filed: Aug. 14, 2006

(51) Int. Cl. H05B 3/02

(52) U.S. Cl. 219/481

(57) ABSTRACT

An electronic control circuit, for use in connection a hot melt adhesive dispensing system, comprises a pair of redundant heater elements which are disposed together in a first, single heater element cartridge body disposed within a first cavity defined within an applicator head, and a pair of redundant temperature sensors which are disposed together within a second, single temperature sensor cartridge body disposed within a second cavity defined within the applicator head. The disposition of both redundant heater elements within the first, single heater element cartridge body, and the disposition of both redundant temperature sensors within the second, single temperature sensor cartridge body permits the applicator head to be reduced in size and rendered more compact, and the electrical connection of the redundant heater elements and the redundant temperature sensors to the power circuit more simplified.

### CROSS-REFERENCE TO RELATED PATENT APPLICATIONS

This patent application is related to U.S. patent application Ser. No. 11/123,053 which is entitled HOT MELT ADHESIVE HOSE ASSEMBLY HAVING REDUNDANT COMPONENTS, and which was filed on May 6, 2005 in the name of Daniel D. Bourget et al., and is also related to U.S. patent application Ser. No. 11/123,028 which is entitled REDUNDANT CONTROL CIRCUIT FOR HOT MELT ADHESIVE HOSE ASSEMBLY HEATER CIRCUITS AND TEMPERATURE SENSORS, and which was also filed on May 6, 2005 in the name of Daniel D. Bourget et al.

### FIELD OF THE INVENTION

The present invention relates generally to hot melt adhesive material dispensing systems, and more particularly to a new and improved redundant control system for controlling the prevailing temperature of the hot melt adhesive material disposed within the applicator head, wherein the new and improved redundant control system comprises a pair of heater elements, a pair of temperature sensors, such as, for example, resistance temperature detectors (RTDs), and redundant logic-controlled circuitry for alternatively connecting one of the pair of heater elements, or one of the pair of temperature sensors, to the electrical power circuit of the hot melt adhesive material supply unit, and wherein, more particularly, the pair of heater elements, and the pair of temperature sensors, are respectively disposed within a single heater cartridge body or housing, or within a single temperature sensor cartridge body or housing, which is disposed within the applicator head. In this manner, should a failure occur within one of the hot melt adhesive material heater elements, or within one of the hot melt adhesive material temperature sensors, logic-controlled switching mechanisms, comprising the redundant logic-controlled circuitry, will be suitably actuated so as to effectively withdraw or remove the failed hot melt adhesive material heater element, or the failed hot melt adhesive material temperature sensor, from its operative or functional disposition within the electrical control circuitry, and substantially simultaneously therewith, insert the backup or redundant hot melt adhesive material heater element, or the backup or redundant hot melt adhesive material temperature sensor, into the electrical control circuitry.

Accordingly, the failed hot melt adhesive material heater element, or the failed hot melt adhesive material temperature sensor, does not need to be replaced immediately but can be subsequently replaced in accordance with, for example, normal scheduled maintenance procedures, whereby the hot melt adhesive material dispensing production line does not need to be shut down for repairs so that extensive downtime, to replace the failed hot melt adhesive material heater element, or the failed hot melt adhesive material temperature sensor, is effectively able to be avoided. In addition, only a single heater cartridge component, comprising the pair of redundant hot melt adhesive material heater elements disposed within the single heater cartridge housing or body, or only a single temperature sensor cartridge component, comprising the pair of redundant hot melt adhesive material temperature sensors disposed within the single temperature sensor cartridge housing or body, needs to be accommodated and installed within the applicator head. Accordingly, the size of the applicator head can effectively be reduced and rendered more compact, and in addition, the number of electrical connections required for electrically connecting the multiple or redundant heater elements and temperature sensors can likewise be reduced. Still yet further, in lieu of the logic-controlled switching mechanisms, manually controlled switching mechanisms may be used.

### BACKGROUND OF THE INVENTION

In connection with hot melt adhesive material dispensing systems, failures can generally occur within two different categories, that is, mechanical failures due to wear, or electrical failures due to electrical malfunctions. More particularly, in connection with the electrical failures that can be experienced, electrical failures can occur, for example, within the heater elements which are used to maintain the hot melt adhesive materials, which are flowing through the applicator heads, at predetermined temperature levels, or within the temperature sensors which are operatively or thermally associated with the hot melt adhesive materials flowing through the applicator heads in order to effectively detect the temperature levels of the hot melt adhesive materials that are flowing through the applicator heads. The actual temperature level values of the hot melt adhesive materials flowing through the applicator heads, as sensed by, for example, the temperature sensors, are effectively conveyed to temperature controllers, and the temperature controllers, in turn, control the energization of the heater elements so that the desired or proper temperature levels of the hot melt adhesive materials are in fact maintained. Maintenance of the proper or desired temperature levels of the hot melt adhesive materials is of course important in order to ensure that the hot melt adhesive materials will be properly dispensed, and provide the desired adhesive properties, once the hot melt adhesive materials are in fact deposited onto particular substrates. It can therefore be appreciated that such failures of the hot melt adhesive material heater elements, or the failures of the hot melt adhesive material temperature sensors, will typically cause the hot melt adhesive material dispensing production line to be shut down for extended periods of time in order to implement the repair or replacement of the failed heater elements, or the failed temperature sensors whereby valuable production time is lost.

In view of the fact that it is important that the aforenoted operation of the hot melt adhesive material dispensing production line is not in fact prematurely terminated due, for example, to a failure within one of the hot melt adhesive material heater elements, or within one of the hot melt adhesive material temperature sensors, the use of redundant or backup hot melt adhesive material heater elements and temperature sensors has been developed. Exemplary systems using such redundant or backup hot melt adhesive material heater elements and temperature sensors disclosed within the aforenoted U.S. patent application Ser. No. 11/123,053, entitled HOT MELT ADHESIVE HOSE ASSEMBLY HAVING REDUNDANT COMPONENTS and filed on May 6, 2005 in the name of Daniel D. Bourget et al., as well as within the aforenoted U.S. patent application Ser. No. 11/123,028, entitled REDUNDANT CONTROL CIRCUIT FOR HOT MELT ADHESIVE HOSE ASSEMBLY HEATER CIRCUITS AND TEMPERATURE SENSORS and likewise filed on May 6, 2005 in the name of Daniel D. Bourget et al.

It is noted, however, that when the redundant or backup hot melt adhesive material heater elements and temperature sensors are actually installed within any one of the various operative components of the hot melt adhesive material dispensing system, such as, for example, the applicator head, each one of the redundant or backup hot melt adhesive material heater elements and temperature sensors must be individually installed within the applicator head, the applicator head must be sufficiently large enough so as to, in effect, have sufficient space to actually accommodate the redundant or backup hot melt adhesive material heater elements and temperature sensors, and the installation of the redundant or backup hot melt adhesive material heater elements and temperature sensors into the redundant control circuitry require additional electrical connections to be made between each one of the individual redundant or backup hot melt adhesive material heater elements and temperature sensors with the other electrical components comprising the redundant control circuitry. Such systems are therefore costly and labor-intensive to manufacture.

A need therefore exists in the art for a new and improved redundant control system, for use in connection with hot melt adhesive material dispensing systems, wherein the new and improved redundant control system would control the prevailing temperature of the hot melt adhesive material disposed, for example, within the applicator head of the hot melt adhesive material dispensing system, wherein the redundant or backup hot melt adhesive material heater elements, as well as the redundant or backup temperature sensors, can effectively be incorporated within single cartridge housings or bodies such that each one of the redundant or backup hot melt adhesive material heater elements and temperature sensors need not be individually installed within the applicator head, the size of the applicator head can accordingly be reduced and rendered more compact, and the installation of the redundant or backup hot melt adhesive material heater elements and temperature sensors into the redundant control circuitry can be achieved with a substantially reduced number of electrical connections defined between each one of the individual redundant or backup hot melt adhesive material heater elements or the hot melt adhesive material temperature sensors, and the other electrical components comprising the redundant control circuitry whereby the new and improved redundant control system would not be so costly and labor-intensive to manufacture.

### SUMMARY OF THE INVENTION

The foregoing and other objectives are achieved in accordance with the teachings and principles of the present invention through the provision of a new and improved redundant control system, for use in connection with hot melt adhesive material dispensing systems, wherein the new and improved redundant control system comprises a pair of heater elements and a pair of temperature sensors so as to effectively define redundant or backup heater elements and temperature sensors. A first one of the redundant heater elements would initially be electrically connected to the redundant control circuitry operatively associated with the hot melt adhesive material supply unit, and in a similar manner, a first one of the redundant temperature sensors would also be electrically connected to the redundant control circuitry operatively associated with the hot melt adhesive material supply unit. Subsequently, should a failure occur within the first one of the redundant heater elements, then a first electrical switch mechanism, either logic-controlled or manually controlled, would be activated so as to effectively remove the first, failed heater element from the redundant control circuitry, and substantially simultaneously therewith, a second electrical switch mechanism would be activated so as to electrically connect the second one of the redundant heater elements to the redundant control circuitry. Similar switching procedures would also be implemented in connection with the pair of redundant temperature sensors should a failure occur within a first one of the redundant temperature sensors initially incorporated within the redundant control circuitry. Still further, in accordance with the specific principles and teachings of the present invention, the pair of redundant or backup hot melt adhesive material heater elements, as well as the pair of redundant or backup temperature sensors, are effectively adapted to be incorporated within single cartridge housings or bodies such that each one of the redundant or backup hot melt adhesive material heater elements and temperature sensors need not be individually installed within the applicator head.

Still further, the size of the applicator head can accordingly be reduced and rendered more compact in view of the fact that the applicator head need not accommodate the pair of redundant or backup heater elements or temperature sensors within individual or separate cartridge housings or bodies. Still yet further, the electrical connection of the redundant or backup heater elements and temperature sensors to or within the redundant control circuitry can be achieved with a substantially reduced number of electrical connections since the electrical connections would now only be defined between each one of the heater element cartridge housings or bodies, containing the pair of redundant or backup heater elements, and the other electrical components comprising the redundant control circuit, or between each one of the temperature sensor cartridge housings or bodies, containing the pair of redundant or backup temperature sensors, and the other electrical components comprising the redundant control circuitry. In this manner, the number of electrical connections within the system is likewise able to be reduced and simplified, thereby also facilitating or permitting the manufacture of the new and improved redundant control system to be more cost-effective.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is an electronic circuit diagram schematically illustrating a first embodiment of a new and improved redundant control system, operatively associated with a hot melt adhesive material dispensing system, developed in accordance with the principles and teachings of the present invention, and showing the cooperative parts thereof, wherein a pair of redundant heater elements and a pair of redundant temperature sensors, along with first and second pairs of switching mechanisms operatively connected to the pair of redundant heater elements and the pair of redundant temperature sensors, respectively, are operatively incorporated within the electrical circuit comprising the new and improved redundant control system such that should a failure occur within a first one of the pair of redundant heater elements, then the first pair of switching mechanisms will be activated, by suitable logic control means, so as to effectively remove the first, failed heater element from the electrical circuit comprising the redundant control system, and substantially simultaneously therewith, electrically connect the second one of the pair of redundant heater elements into the electrical circuit comprising the redundant control system, while in a similar manner, should a failure occur within a first one of the pair of redundant temperature sensors, the second pair of switching mechanisms will be activated, by the logic control means, so as to effectively remove the first, failed temperature sensor from the electrical circuit comprising the redundant control system, and substantially simultaneously therewith, electrically connect the second one of the pair of redundant temperature sensors into the electrical circuit comprising the redundant control system; and

FIG. 2 is an electronic circuit diagram, similar to that of FIG. 1, schematically illustrating, however, a second embodiment of a new and improved redundant control system, operatively associated with a hot melt adhesive material dispensing system, developed in accordance with the principles and teachings of the present invention, and showing the cooperative parts thereof, wherein a pair of redundant heater elements and a pair of redundant temperature sensors, along with first and second pairs of switching mechanisms operatively connected to the pair of redundant heater elements and the pair of redundant temperature sensors, respectively, are operatively incorporated within the electrical circuit comprising the new and improved redundant control system such that should a failure occur within a first one of the pair of redundant heater elements, then the first pair of switching mechanisms will be activated, by suitable manual control means, so as to effectively remove the first, failed heater element from the electrical circuit comprising the redundant control system, and substantially simultaneously therewith, electrically connect the second one of the pair of redundant heater elements into the electrical circuit comprising the redundant control system, while in a similar manner, should a failure occur within a first one of the pair of redundant temperature sensors, the second pair of switching mechanisms will be activated, by the manual control means, so as to effectively remove the first, failed temperature sensor from the electrical circuit comprising the redundant control system, and substantially simultaneously therewith, electrically connect the second one of the pair of redundant temperature sensors into the electrical circuit comprising the redundant control system.

### DETAILED DESCRIPTION OF THE ILLUSTRATED EMBODIMENTS

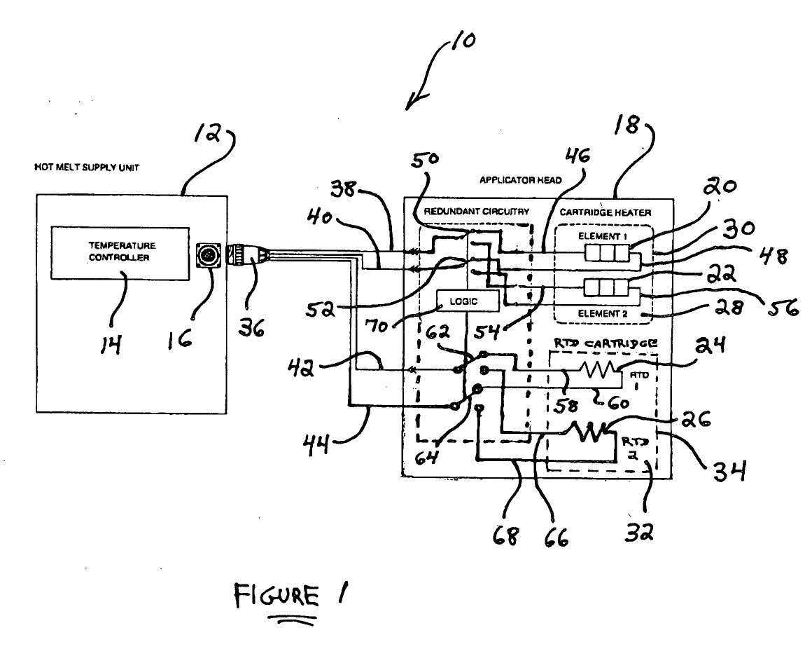

Referring now to the drawings, and more particularlarly to FIG. 1 thereof, a first embodiment of a new and improved redundant control system or circuit, which has been developed in accordance with the principles and teachings of the present invention, which shows the cooperative parts thereof, and which is adapted to be operatively associated with, for example, an applicator head of a hot melt adhesive material dispensing system, is disclosed and is generally indicated by the reference character 10. More particularly, it is seen that the new and improved redundant control system or circuit 10 comprises a hot melt adhesive material supply unit 12 within which there is disposed a temperature controller 14, and a female electrical connector 16 is also disposed within the hot melt adhesive material supply unit 12 for receiving electrical power from a main power supply, not shown. An applicator head 18 is adapted to receive a supply of hot melt adhesive material from the hot melt adhesive material supply unit 12, and a pair of heater elements 20,22, as well as a pair of temperature sensors 24,26 are disposed within the applicator head 18. The pair of heater elements 20,22 therefore comprise first and second heater elements which effectively serve as redundant or backup heater elements with respect to each other in the case that one of the heater elements should experience an operational failure, and in a similar manner, the pair of temperature sensors 24,26 likewise comprise first and second temperature sensors which also effectively serve as redundant or backup temperature sensors with respect to each other in the case that one of the temperature sensors should experience an operational failure.

In accordance with further principles and teachings of the present invention, it is also seen that both of the redundant or backup heater elements 20,22 are disposed within a single heater element cartridge body or housing 28 which is disposed within a suitable single cavity, recess, or bore 30 formed or defined within the applicator head 18, and in a similar manner, both of the redundant or backup temperature sensors 24,26 are disposed within a single temperature sensor cartridge body or housing 32 which is disposed within a suitable single cavity, recess, or bore 34 which is also formed or defined within the applicator head 18. In view of these structural arrangements of the dual, redundant, or backup heater elements 20,22, wherein the same are disposed within the single heater element cartridge body or housing 28 which, in turn, is disposed within the single cavity, recess, or bore 30 formed or defined within the applicator head 18, as well as the structural arrangements of the dual, redundant, or backup temperature sensors 24,26, wherein the same are disposed within the single temperature sensor cartridge body or housing 32 which, in turn, is disposed within the single cavity, recess, or bore 34 formed or defined within the applicator head 18, the size of the applicator head 18 can be substantially reduced and rendered more compact in view of the fact that the applicator head 18 need not accommodate the pair of redundant or backup heater elements 20,22, or the pair of temperature sensors 24, 26, within individual or separate heater element or temperature sensor cartridge housings or bodies which would necessarily be disposed within spatially separated cavities, recesses, or bores defined within the applicator head 18.

Continuing further, it is seen that a male electrical connector 36 is adapted to be electrically connected to the female electrical connector 16 disposed within the hot melt adhesive material supply unit 12 in order to receive and conduct electrical power from the female electrical connector 16, and the main power supply, not shown, to the pair of redundant or backup heater elements 20,22 and the pair of redundant or backup temperature sensors 24, 26. More particularly, the male electrical connector 36 is adapted to be electrically connected to the pair of redundant or backup heater elements 20, 22 by means of a first pair of power lines 38, 40, and is likewise adapted to be electrically connected to the pair of redundant or backup temperature sensors 24, 26 by means of a second pair of power lines 42, 44. In addition, in connection with the pair of redundant or backup heater elements 20, 22, it is seen that the first one of the pair of redundant or backup heater elements 20 is adapted to be electrically connected to the first pair of power lines 38, 40 through means of a first pair of electrical connection lines 46, 48 and a first pair of two-position switch mechanisms 50, 52 collectively defining four electrical terminals, while in a similar manner, the second one of the pair of redundant or backup heater elements 22 is adapted to be electrically connected to the first pair of power lines 38, 40 through means of a second pair of electrical connection lines 54, 56 and the first pair of two-position switch mechanisms 50, 52. It can therefore be appreciated that when the first pair of two-position switch mechanisms 50, 52 are disposed at their first positions, as illustrated within FIG. 1, at which the first pair of two-position switch mechanisms 50, 52 are disposed in electrical contact with the first and third terminals, the first one of the pair of redundant or backup heat elements 20 will be electrically connected into the electrical power circuit so as to receive electrical power through means of the electrical connectors 16, 36 electrically connected together within the hot melt adhesive material supply unit 12, whereas conversely or alternatively, when the first pair of two-position switch mechanisms 50, 52 are effectively switched over so as to be disposed at second positions at which the first pair of two-position switch mechanisms 50, 52 will be disposed in electrical contact with the second and fourth terminals, the second one of the pair of redundant or backup heat elements 22 will be electrically connected into the electrical power circuit so as to receive electrical power from the electrical connectors 16, 36 electrically connected together within the hot melt adhesive material supply unit 12.

In a similar manner, in connection with the pair of redundant or backup temperature sensors 24, 26, it is seen that the first one of the pair of redundant or backup temperature sensors 24 is adapted to be electrically connected to the second pair of power lines 42, 44 through means of a third pair of electrical connection lines 58, 60 and a second pair of two-position switch mechanisms 62, 64 which also collectively define four terminals. In addition, the second one of the pair of redundant or backup temperature sensors 26 is adapted to be electrically connected to the second pair of power lines 42, 44 through means of a fourth pair of electrical connection lines 66, 68 and the second pair of two-position switch mechanisms 62, 64.

It can thus be appreciated that when the second pair of two-position switch mechanisms 62, 64 are disposed at their first positions, as illustrated within FIG. 1, at which the second pair of two-position switch mechanisms 62, 64 are disposed in electrical contact with the first and third terminals, the first one of the pair of redundant or backup temperature sensors 24 will be electrically connected into the electrical power circuit so as to receive electrical power through means of the electrical connectors 16, 36 electrically connected together within the hot melt adhesive material supply unit 12, whereas alternatively or conversely, when the second pair of two-position switch mechanisms 62, 64 are effectively switched over so as to be disposed at second positions at which the second pair of two-position switch mechanisms 62, 64 will be disposed in contact with the second and fourth terminals, the second one of the pair of redundant or backup temperature sensors 26 will be electrically connected into the electrical power circuit so as to receive electrical power from the electrical connectors 16, 36 electrically connected together within the hot melt adhesive material supply unit 12. Still yet further, it is also seen that a suitable LOGIC control system 70, comprising, for example, a MICROCONTROLLER, an EEPROM, and the like, as more particularly disclosed within the aforenoted U.S. patent application Ser. No. 11/123,028, which is entitled REDUNDANT CONTROL CIRCUIT FOR HOT MELT ADHESIVE HOSE ASSEMBLY HEATER CIRCUITS AND TEMPERATURE SENSORS, which was filed on May 6, 2005 in the name of Daniel D. Bourget et al., and which is hereby incorporated herein by reference, is adapted to control the positions of the first and second two-position switch mechanisms 50, 52 and 62,64. It is noted that the control of the positions of the first and second two-position switch mechanisms 50, 52, and 62, 64, is achieved in accordance with, for example, suitable voltage and current feedback readings which are obtained from the pair of redundant or backup heater elements 20, 22, and from the pair of redundant or backup temperature sensors 24, 26, as is also more particularly disclosed within the aforenoted patent application.

It can therefore be appreciated still further that by effectively incorporating both of the redundant or backup heater elements 20, 22 within the single heater element cartridge housing or body 28, whereby, for example, all of the electrical connection lines 46, 48, 54, 56, operatively associated with the single heater element cartridge housing or body 28, will, in effect, be gathered or collected together into a single wiring harness or electrical connector for respective electrical connection to the four terminals of the first pair of two-position switch mechanisms 50, 52, the number of electrical connections between the pair of redundant or backup heater elements 20, 22 and the two-position switch mechanisms 50, 52 can effectively be reduced and simplified, thereby rendering the manufacture of the new and improved redundant control system 10 of the present invention more cost-effective. Similar attributes are also characteristic of effectively incorporating both of the redundant or backup temperature sensors 24, 26 within the single temperature sensor cartridge body or housing 32, whereby, for example, all of the electrical connection lines 58, 60, 66, 68, operatively associated with the single temperature sensor cartridge housing or body 32, will, in effect, be gathered or collected together into a single wiring harness or electrical connector for respective electrical connection to the four terminals of the second pair of two-position switch mechanisms 62, 64.

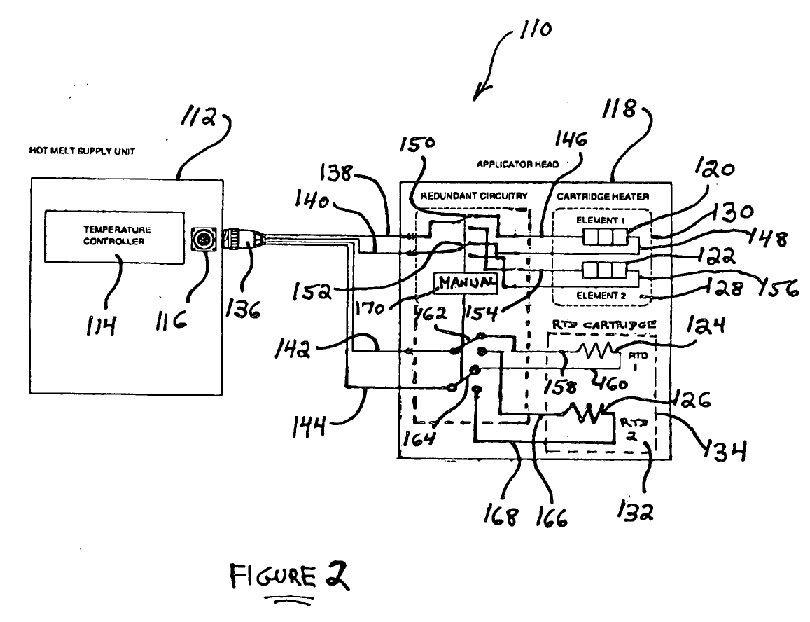

With reference now being made to FIG. 2, a second embodiment of a new and improved redundant control system or circuit, which has also been developed in accordance with the principles and teachings of the present invention, which shows the cooperative parts thereof, and which is likewise adapted to be operatively associated with, for example, an applicator head of a hot melt adhesive material dispensing system, is disclosed and is generally indicated by the reference character 110. It is noted that in view of the similarity of the second embodiment redundant control system or circuit 110 as disclosed within FIG. 2, when compared to the first embodiment redundant control system or circuit 10 as disclosed within FIG. 1, a detailed description of the second embodiment redundant control system or circuit 110 will be omitted herefrom, except to note the particular differences between the second embodiment redundant control system or circuit 110 as disclosed within FIG. 2, and the first embodiment redundant control system or circuit 10 as disclosed within FIG. 1, and in addition, it is further noted that the structural components of the second embodiment redundant control system or circuit 110, as disclosed within FIG. 2, which correspond to similar structural components of the first embodiment redundant control system or circuit 10, as disclosed within FIG. 1, will be designated by similar or corresponding reference characters except that they will be within the 100 series. More particularly, it is seen that the only significant difference between the second embodiment redundant control system or circuit 110, as disclosed within FIG. 2, and the first embodiment redundant control system or circuit 10, as disclosed within FIG. 1, resides in the fact that in lieu of the LOGIC control mechanisms 70, the switchover of the first and second pairs of two-position switch mechanisms 50, 52 and 62, 64 can be performed or achieved by suitable MANUAL controls 170 as more particularly disclosed and described, for example, within the aforenoted U.S. patent application Ser. No. 11/123,053 which is entitled HOT MELT ADHESIVE HOSE ASSEMBLY HAVING REDUNDANT COMPONENTS, which was filed on May 6, 2005 in the name of Daniel D. Bourget et al., and which is hereby incorporated herein by reference.

Thus, it may be seen that in accordance with the principles and teachings of the present invention, there has been disclosed and described a new and improved redundant control system, for use in connection with hot melt adhesive material dispensing systems, wherein the new and improved redundant control system comprises a pair of heater elements and a pair of temperature sensors so as to effectively define redundant or backup heater elements and temperature sensors.

A first one of the redundant heater elements would initially be electrically connected to the redundant control circuitry operatively associated with the hot melt adhesive material supply unit, and in a similar manner, a first one of the redundant temperature sensors would also be electrically connected to the redundant control circuitry operatively associated with the hot melt adhesive material supply unit. Subsequently, should a failure occur within the first one of the redundant heater elements, then a first electrical switch mechanism, either logic-controlled or manually controlled, would be activated so as to effectively remove the first, failed heater element from the redundant control circuitry, and substantially simultaneously therewith, a second electrical switch mechanism would be activated so as to electrically connect the second one of the redundant heater elements to the redundant control circuitry. Similar switching procedures would also be implemented in connection with the pair of redundant temperature sensors should a failure occur within a first one of the redundant temperature sensors initially incorporated within the redundant control circuitry.

Still further, in accordance with the specific teachings and principles of the present invention, the pair of redundant or backup hot melt adhesive material heater elements, as well as the pair of redundant or backup temperature sensors, are effectively adapted to be incorporated within single cartridge housings or bodies such that each one of the redundant or backup hot melt adhesive material heater elements and temperature sensors need not be individually installed within the applicator head. The size of the applicator head can accordingly be reduced and rendered more compact in view of the fact that the applicator head need not accommodate the pair of redundant or backup heater elements or temperature sensors within individual or separate cartridge housings or bodies. Still yet further, the electrical connection of the redundant or backup heater elements and temperature sensors to or within the redundant control circuitry can be achieved with a substantially reduced number of electrical connections since the electrical connections would now only be defined between each one of the heater element cartridge housings or bodies, containing the pair of redundant or back-up heater elements, and the switching components comprising the redundant control circuit, or between each one of the temperature sensor cartridge housings or bodies, containing the pair of redundant or backup temperature sensors, and the switching components comprising the redundant control circuitry. In this manner, the number of electrical connections is likewise able to be reduced and simplified, thereby rendering the manufacture of the new and improved redundant control system more cost-effective.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by letters: PATENT OF THE UNITED STATES OF AMERICA, IS:

1. An electronic control system for use in connection with hot melt adhesive material dispensing equipment, comprising:
an electrical power source;
a component within which hot melt adhesive material is to be heated;
a cavity defined within said component;
a pair of redundant heater elements disposed within said component for heating the hot melt adhesive material, disposed within said component, to a predetermined temperature level, wherein both of said pair of redundant heater elements are disposed within a single heater element cartridge housing body which is disposed within said cavity defined within said component;
at least one temperature sensor disposed within said component for sensing the temperature level of the hot melt adhesive material disposed within said component; and
switching means for selectively and alternatively electrically connecting either one of said pair of said redundant heater elements to said electrical power source.

2. The electronic control system as set forth in claim 1, wherein:
said component comprises a hot melt adhesive material applicator head.

3. The electronic control system as set forth in claim 1, wherein said switching means comprises:
a pair of two-position switches comprising four terminals wherein when each one of said pair of two-position switches are disposed at first positions electrically connecting first and third ones of said four terminals to said electrical power source, a first one of said pair of redundant heater elements will be electrically connected to said electrical power source, whereas, when each one of said pair of two-position switches are disposed at second positions electrically connecting second and fourth ones of said four terminals to said electrical power source, a second one of said pair of redundant heater elements will be electrically connected to said electrical power source.

4. The electronic control system as set forth in claim 1, further comprising:
means for controlling said switching means for respectively switching said switching means between said first and second positions.

5. The electronic control system as set forth in claim 4, wherein:
said means for controlling said first switching means comprises logic-controlled means.

6. The electronic control system as set forth in claim 4, wherein:
said means for controlling said switching means comprises manually-controlled means.

7. The electronic control system as set forth in claim 1, further comprising:
temperature controller means for receiving signals from said at least temperature sensor, indicative of the temperature levels of the hot melt adhesive material disposed within said component, and for controlling the energization of said pair of redundant heater elements in response to the temperature levels, sensed by said at least one temperature sensor, of the hot melt adhesive material disposed within said component.

8. An electronic control system for use in connection with hot melt adhesive material dispensing equipment, comprising:
an electrical power source;
a component within which hot melt adhesive material is to be heated;
a cavity defined within said component;
at least one heater element disposed within said component for heating the hot melt adhesive material, disposed within said component, to a predetermined temperature level;
a pair of redundant temperature sensors disposed within said component for sensing the temperature level of the hot melt adhesive material disposed within said component, wherein both of said pair of redundant temperature sensors are disposed within a single temperature sensor cartridge housing body which is disposed within said cavity defined within said component; and
switching means for selectively and alternatively electrically connecting either one of said pair of said redundant temperature sensors to said electrical power source.

9. The electronic control system as set forth in claim 8, wherein:
said component comprises a hot melt adhesive material applicator head.

10. The electronic control system as set forth in claim 8, wherein said switching means comprises:
a pair of two-position switches comprising four terminals wherein when each one of said pair of two-position switches are disposed at first positions electrically connecting first and third ones of said four terminals to said electrical power source, a first one of said pair of redundant temperature sensors will be electrically connected to said electrical power source, whereas, when each one of said pair of two-position switches are disposed at second positions electrically connecting second and fourth ones of said four terminals to said electrical power source, a second one of said pair of redundant temperature sensors will be electrically connected to said electrical power source.

11. The electronic control system as set forth in claim 8, further comprising:
means for controlling said switching means for respectively switching said switching means between said first and second positions.

12. The electronic control system as set forth in claim 11, wherein:
said means for controlling said first switching means comprises logic-controlled means.

13. The electronic control system as set forth in claim 11, wherein:
said means for controlling said switching means comprises manually-controlled means.

14. The electronic control system as set forth in claim 10, further comprising:
temperature controller means for receiving signals from said pair of redundant temperature sensors, indicative of the temperature levels of the hot melt adhesive material disposed within said component, and for controlling the energization of said at least one heater element in response to the temperature levels, sensed by said pair of redundant temperature sensors, of the hot melt adhesive material disposed within said component.

15. An electronic control system for use in connection with hot melt adhesive material dispensing equipment, comprising:
an electrical power source;
a component within which hot melt adhesive material is to be heated;
a first cavity defined within said component;
a pair of redundant heater elements disposed within said component for heating the hot melt adhesive material, disposed within said component, to a predetermined temperature level, wherein both of said pair of redundant heater elements are disposed within a first single heater element cartridge housing body which is disposed within said first cavity defined within said component;
first switching means for selectively and alternatively electrically connecting either one of said pair of said redundant heater elements to said electrical power source;
a second cavity defined within said component;
a pair of redundant temperature sensors disposed within said component for sensing the temperature level of the hot melt adhesive material disposed within said component, wherein both of said pair of redundant temperature sensors are disposed within a single temperature sensor cartridge housing body which is disposed within said second cavity defined within said component; and
second switching means for selectively and alternatively electrically connecting either one of said pair of said redundant temperature sensors to said electrical power source.

16. The electronic control system as set forth in claim 15, wherein:
said component comprises a hot melt adhesive material applicator head.

17. The electronic control system as set forth in claim 15, wherein said first and second switching means comprises:
a first pair of two-position switches comprising four terminals wherein when each one of said second pair of two-position switches are disposed at first positions electrically connecting first and third ones of said four terminals to said electrical power source, a first one of said pair of redundant heater elements will be electrically connected to said electrical power source, whereas, when each one of said second pair of two-position switches are disposed at second positions electrically connecting second and fourth ones of said four terminals to said electrical power source, a second one of said pair of redundant heater elements will be electrically connected to said electrical power source; and
a second pair of two-position switches comprising our terminals wherein when each one of said second pair of two-position switches are disposed at first positions electrically connecting first and third ones of said four terminals to said electrical power source, a first one of said pair of redundant temperature sensors will be electrically connected to said electrical power source, whereas, when each one of said second pair of two-position switches are disposed at second positions electrically connecting second and fourth ones of said four terminals to said electrical power source, a second one of said pair of redundant temperature sensors will be electrically connected to said electrical power source.

18. The electronic control system as set forth in claim 15, further comprising:
means for controlling said first and second switching means for respectively switching said first and second switching means between said first and second positions.

19. The electronic control system as set forth in claim 18, wherein:
said means for controlling said first and second switching means is selected from the group comprising logic-controlled means and manually-controlled means.

20. The electronic control system as set forth in claim 15, further comprising:
temperature controller means for receiving signals from said pair of redundant temperature sensors, indicative of the temperature levels of the hot melt adhesive material disposed within said component, and for controlling the energization of said pair of redundant heater elements in response to the temperature levels, sensed by said pair of redundant temperature sensors, of the hot melt adhesive material disposed within said component.
